(19) United States
(12) Patent Application Publication
(10) Pub. No.: US 2001/0003177 A1
(43) Pub. Date: Jun. 7, 2001

(54) Printed medium activated interactive communication

(75) Inventors: Robert J. Schena, Wayne, PA (US); Mike Anderer, Salt Lake City, UT (US); Peter B. Ritz, Meadowbrook, PA (US); Mike Bernstein, Tucson, AZ (US)

Correspondence Address: Gregory J. Lavorgna, Seidel, Gonda, Lavorgna Monaco, P.C., Suite 1800, Two Penn Center Plaza, Philadelphia, PA, 19102, US

(73) Assignee: Silicon Stemcell, LLC

(21) Appl. No.: 09/768,800

(22) Filed: Jan. 24, 2001

Related U.S. Application Data
(62) Division of application No. 09/310,355, filed on May 12, 1999.

(51) Int. Cl. G06F 17/60

(52) U.S. Cl. 705/27

(57) ABSTRACT

Methods and apparatus are disclosed for bridging the gap between the virtual multimedia-based Internet world and the physical world of tangible object media, such as print media. More particularly, the methods are based on initiating a communication from a printed medium or other object containing provider information using a scanner, a portal server and a receiver connected across a network. The method involves scanning a machine-readable code corresponding to the provider information from the object using the scanner and storing the machine-readable code in a memory. The provider information may include network link information, or it may include information from which a default portal server can deduce an appropriate link automatically. The link information is then extracted from the machine readable code in the memory. A user input information corresponding to the provider information may also be obtained and stored in the memory. The link information and the user input information are then sent to the portal server via the network. The portal server receives the link information and user input information and selects a multimedia information sequence or initiates another desired transaction corresponding to the link information and the user input information. The multimedia information sequence is sent to the receiver via the network. The receiver receives and stores the multimedia information sequence, and plays the sequence automatically or in response to a stimulus, such as a user request.

### CROSS-REFERENCE TO RELATED APPLICATIONS

This application is related to U.S. application Ser. No. 09/236,176, filed Jan. 25, 1999 and entitled “PRINTED MEDIUM ACTIVATED INTERACTIVE COMMUNICATION OF MULTIMEDIA INFORMATION, INCLUDING ADVERTISING.” and to U.S. application Ser. No. 09/295,823, filed Apr. 21, 1999 and entitled “METHOD FOR MANAGING PRINTED MEDIUM ACTIVATED REVENUE SHARING DOMAIN NAME SYSTEM SCHEMAS”.

### FIELD OF THE INVENTION

The present invention is related to bridging the gap between the virtual multimedia-based Internet world and the physical world of tangible object media. More particularly, the invention relates to systems and methods for communicating information across a network based on initiating a communication from an object containing provider information in the form of a machine-readable code, using a scanner capable of reading the code, a portal server and a receiver connected across a network.

### BACKGROUND OF THE INVENTION

Scanner technology has been used for many years in many contexts. By way of example, scanners are used in supermarkets, with personal computers, and in inventory, manufacturing, and resource control systems. However, scanner technology has not previously been thought of as a means to bridge the gap between static printed media and the “virtual world” of interactivity, which includes the Internet, advertising, entertainment, and electronic commerce.

Printed media have been the primary source of communicating information, including news and advertising information, for centuries. The advent of the Internet over the past few decades has expanded the concept of printed media by making it available in an electronically readable and searchable form and by introducing interactive multi-media capabilities unparalleled by traditional printed media. Unfortunately, many users of printed media do not possess the requisite technical expertise to use the Internet as an efficient source of information. Thus, although almost everyone in the world has access to printed media on a daily basis, only a small percentage of those people possess the requisite technical expertise to use the Internet.

There exists a need for that can link all users of printed media and tangible object media to the “virtual world” and that can deliver desired information to the user without regard to the user's technical expertise. The present invention provides such a method by using scanner technology to bridge the gap between tangible object media, the virtual world of interactivity and the Internet. Moreover, the systems and methods described herein enable those controlling the tangible object media, such as print media, to enhance their presentation of information to their customers by providing them with a multimedia experience unavailable in traditional printed media.

### SUMMARY OF THE INVENTION

According to one aspect, the present invention comprises a method of communicating news information via a network that connects a scanner, a portal server, and a receiver. The method comprises providing a printed medium containing information including human-readable news information and a machine-readable code containing a link information related to the human-readable news information. The user scans the machine-readable code from the printed medium using the scanner. The scanner stores the machine-readable code in a memory, extracts the link information from the machine readable code in the memory, and may also obtain and store user input information in the memory. The scanner then sends the link information and the user input information to the portal server via the network. The portal server receives the link information and the user input information, selects a multimedia news information sequence corresponding to the link information and the user input information, and sends the multimedia information sequence to the receiver via the network. The receiver receives, stores, and plays the multimedia information sequence.

According to a preferred embodiment, the portal server stores the link information and the user input information. The portal server subsequently identifies newly-available multimedia news information, selects newly-available multimedia news information sequences relevant to the stored news information and user input information, and sends the newly-available multimedia information sequence to the receiver via the network. The receiver then receives, stores, and plays the multimedia information sequence.

According to another aspect, the present invention comprises a method of distributing vendibles, such as goods and services, using a network connecting a scanner, a portal server, and a receiver. An object, which may be a printed medium, containing at least human-readable information and machine-readable codes identifying vendibles is provided. A user scans one of the machine-readable codes containing information identifying a desired vendible using the scanner. The scanner stores the machine-readable code in a memory, and may also obtain and store in the memory a user input information further identifying the desired vendible. The scanner then sends the stored information and information identifying the user to the portal server via the network. The portal server receives the said information, and selects a supplier of a vendible appropriate to the stored information.

The supplier may deliver the vendibles to the user, at a location indicated by said information identifying the user. Instead, the portal server may send to the receiver information identifying a location of the supplier, and the user may then go to the location of the supplier. The information identifying the location of the supplier may include not merely an address, but directions from the user's location to the supplier's premises, and even to a particular place within the premises.

The portal server may identify a plurality of possible suppliers, procure information from the suppliers with respect to vendibles supplied by each of them, and selecting one supplier by a process of comparison shopping.

If the scanner, is mobile, it is then preferably capable of determining its own current location and reporting that location to the portal server as part of the information identifying the user. The scanner may include a receiver for GPS or other broadcast position signals. The portal server can then select a supplier convenient to the identified location of said scanner.

If the suppliers are mobile, the server may determine the current locations of possible suppliers, and compare the current locations of possible suppliers and the user when selecting a supplier.

According to another aspect, the invention comprises a system for communicating information via a telecommunications network by initiating a communication from a printed medium or other object containing scannable provider information. The system comprises telecommunications apparatus including a scanner capable of receiving data by scanning from such an object. The data comprises link information corresponding to the provider information. The scanner comprises a memory capable of storing the link information, and a user interface for receiving user input information, the user input information capable of being stored in the memory. The apparatus is capable of communicating the link information and the user input information via the network and receiving information via the network. The system also comprises a portal server in communication with the telecommunications apparatus via the network. The portal server receives the link information and the user input information, selects an information sequence corresponding to the link information and the user input information, and causes the information sequence to be transmitted via the network to the telecommunications apparatus.

If the telecommunications apparatus comprises a telephone, the portal server is preferably capable of transmitting information to the telephone in the form of synthesized speech. Especially preferably, the portal server is capable of communicating with a user by means of synthesized speech replayed by the telephone to the user and user input entered on a keypad of the telephone.

If the telecommunications apparatus includes a facsimile machine for receiving information from the telecommunications network, the portal server is preferably capable of sending facsimile messages that include codes readable by the said scanner.

According to another aspect, the intention provides a method of commercial administration using a network connecting a scanner, a portal server, and a receiver. The method comprises generating a written record of a transaction, including machine-readable code. The code at least identifies the transaction and identifies a database containing records of the transaction and accessible from the network via the portal server. A user scans the machine-readable code using the scanner. The scanner stores the machine-readable code in a memory, and may also obtain and store user input information. The scanner then sends the stored information and information identifying the user to the portal server via the network. The portal server receives the information, and permits the user to access the records of the transaction in the said database.

According to another aspect, the invention comprises a method of contact administration using a network connecting a scanner, a portal server, and a receiver. A person distributes business cards that identify and provide contact details for the person and include machine-readable code at least identifying the person. A user who has received such a card scans the machine-readable code using the scanner. The scanner stores the machine-readable code in a memory, and sends the stored information and information identifying the user to the portal server via the network. The portal server receives the information, and stores in a database associated with the said person at least the information identifying the said user. If the contact details of the said person subsequently change, the server notifies at least some users identified in the said database of the changes.

According to another aspect, the invention provides a system for backup of electronic data, comprising a printer capable of printing data to be backed up in the form of a machine-readable code; and a scanner capable of reading data printed in the said machine-readable code.

According to another aspect, the invention provides a data-handling device comprising a scanner for reading printed codes, the scanner arranged to scan a laser beam over the printed code and detect modulation in the intensity of the reflected light; and a projector arranged to project an image by scanning the same laser beam over a surface while modulating the intensity of the beam.

According to another aspect, the invention provides apparatus for selection of entertainment programs. The apparatus comprises a printed medium containing entries giving human-readable information on respective available entertainment programs, and each including a machine-readable code; a scanner capable of scanning the machine readable codes; and apparatus responsive to a scanned code to provide to a user a respective entertainment program.

The apparatus may comprise a portal server connected to the scanner via a network and a receiver connected to the portal server via the network. The scanner is capable of transmitting scanned code to the portal server, and the portal server is responsive to the transmitted scan to transmit the appropriate entertainment program to the receiver, or to transmit to said receiver information enabling said receiver to show said entertainment program to a user.

The portal server can preferably cause the user to be charged any applicable “pay-per-view” fee for viewing a program.

### BRIEF DESCRIPTION OF THE DRAWINGS

FIG. 1 depicts an embodiment of a system performing a method of the present invention using a receiver to communicate with both a scanner and a portal server.

FIG. 2 depicts an embodiment of a system performing a method of the present invention wherein the scanner communicates with a portal server directly without a receiver.

FIG. 3 depicts an embodiment of a system performing a method of the present invention wherein the scanner and the customer premises equipment are integrated into one device.

FIG. 4 depicts an embodiment of a system performing a method of the present invention wherein the a customer premises equipment is separate from the receiver and the scanner.

### DETAILED DESCRIPTION OF THE INVENTION

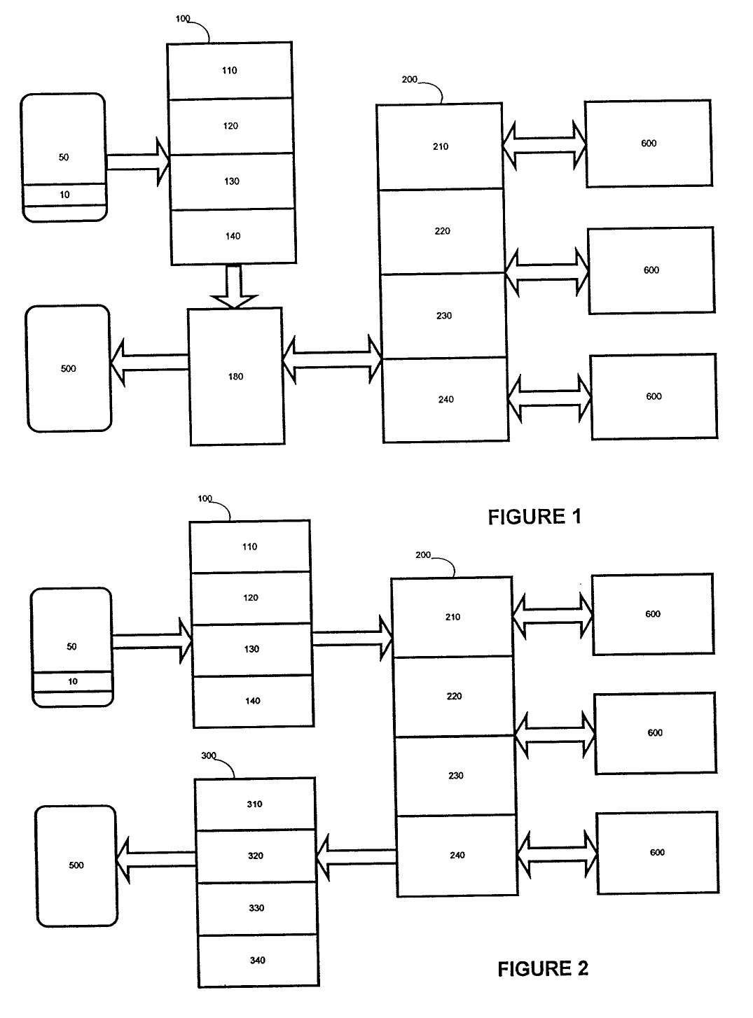

FIG. 1 depicts an embodiment of a system performing a method of the present invention including three components: a scanner 100, a receiver 180, and a portal server 200. In one embodiment, the scanner 100 and the receiver 180 comprise into a single device. In another embodiment, the scanner 100 communicates with the portal server 200 directly, and a customer premises equipment (“CPE”) 300, serving as the receiver 180, plays multimedia sequence information received from the portal server 200.

The scanner 100 may be a handheld device, preferably, but not necessarily, wireless. The scanner 100 may be, for example, an enhanced existing electronic device, a TV remote control, a mouse, a telephone, a cell phone, a PC card device, a palmtop, a calculator, a key chain, a pen, an identification card, a smart card, a hand held GPS (Global Positioning System) device, a desktop or laptop computer, a digital appliance, a microprocessor-based device, a personal digital assistant, a pager or a two-way pager. Especially when the scanner 100 and the receiver 180 are combined in a single small portable device, such as a pager or even a cell phone, it is difficult to provide a practical alphabetic keyboard. It is therefore a major advantage of the present invention when the machine-readable code 10 contains sufficient information that any subsequent interaction between the user and the server 200 can be conducted either with limited choice menus or by scanning further machine-readable codes 10. The problem of providing a practical keyboard on a small device can then be solved by rendering a full keyboard unnecessary.

Some processing is typically necessary to convert the code 10 into a form that can be transmitted to a portal server 200, so if the scanner 100 is a dumb device such as a mouse it is preferably connected directly to a receiver 180 having significant data-processing capacity.

The scanner 100 is capable of reading data such as non-coded data and machine-readable code 10 from a printed medium or other object 50. The machine-readable code 10 may be a barcode, an enhanced barcode, a new enhanced code, or any type of code, including dynamic codes and high density barcodes.

In one embodiment, the code 10 contains a link information corresponding to a provider information from the printed medium 50. The link information may correspond to any of a universal resource locator (“URL”), an Internet address information, a telephone number, network address information, a trademark information, a source of origin, an organization name, a product name, a service name, a benefit redemption information, a provider defined information, a user personal profile information (i.e., “a cookie”), a user interest information, a server command information, and a customer premises equipment preference information.

If the printed medium is a printout of a page from the World Wide Web, then the code 10 may be generated by an electronic watermark that appears only when the page is printed out, and does not obtrude when the page is viewed on-line. The watermark may then be a fixed reference, or may be generated dynamically when the page is downloaded.

The link information may be an alphanumeric sequence printed in form of the machine-readable code 10. The alphanumeric sequence may be assigned to the printed medium 50 by the provider 600 and may be encoded according to the provider's preference. The alphanumeric sequence may activate and result in the playing of the multimedia sequence information 500. For example, a machine-readable code 10 on the printed advertisement for an automobile may translate into the following alphanumeric sequence “A001B0990799A5557ZQZ6898”. The “A001” designation may correspond to a template on the scanner 100 enabling Ford to present a person with a user input information asking whether the person is interested in advertisements, transactions, or both. The “B099” designation may refer to a type and name of the magazine which carried the ad. The “0799” designation may refer to July 1999 issue from advertiser A5557 which might be a local automobile dealer. The “ZQZ6898” designation may be the network code and could refer to a network address at the portal server 200 or to a link table. Existing UPC or ISBN numbers may serve as the alphanumeric sequence. At least one of the scanner 100, the receiver 180, or the portal server 200, may extract the provider information from such alphanumeric sequence and translate it into a network address at the portal server 200 or a link table.

In one embodiment, the printed medium 50 is a news periodical, and a printed code 10 is provided at the end of each individual news article (not shown). The code then prompts the portal server 200 to supply an on-line version of the original article, an update of the original article, or a multimedia sequence containing more information on the news event that was the subject of the original printed article. Instead, or in addition, the portal server 200 may send to the receiver 180 an interactive prompt offering options to request further information, hyperlinks to information on related topics, or future updates of the news item. Any such request for future updates may be tied to a user personal profile, and/or to a profile for a particular receiver 180. The receiver profile determines both the format of the updates and the manner of notifying new updates to the user.

According to an embodiment of the invention, if the connection from the scanner 100 to the portal server 200 is not suitable for immediate transmission, then the scanner 100 or an intermediate device stores and queues scans and sends them in a batch when the connection is available, or when the number of queued scans is sufficient to justify a transmission overhead, or when instructed by the user. Instead, or in addition, further information to be sent from the portal server 200 to the receiver 180 or customer premises equipment 300 can be queued either at the server or at an intermediate device. For example, when the scanner 100 and/or the receiver 180 is a pager, the different natures of the connections from the pager to the paging service (not shown) and from the paging service to the portal server 200 may make it expedient to queue either scans or downloads at the paging service. Also, if the user has requested later updates of information downloaded, the portal server 200 can actively send updates, or notifications of updates, for example, to a pager or e-mail receiver, and can retain updates until the user's receiver 180 next establishes contact with the server, where the receiver 180 is not continuously accessible.

The code 10 comprises at least one of the link information, and a publication information (ie., where the information was published or located), along with a demographic and other advertising or message-specific information provided by a provider 600. The code 10 may also comprise personal and provider security information.

A method of the invention includes using the system to collect and manage code 10 that lacks link information. This linkless code information may be added to the cookie along with any additional user input information. The code 10 is capable of being read by a scanner 100 or a transducer generating and transmitting the link information based upon a stimulus. The scanner 100 or transducer is capable of differentiating between information and data contained within code 10. One type of the code 10 may be an information-only type that would link to an information page. A simple example of this would be a scanned universal product code (“UPC”) printed on a can of food linking a person using the system to the manufacturer's information on nutrition, recipe, or transaction information. The system can also process UPC codes by directing them to a link table to resolve the link without any added codes. The system is capable of processing the ISBN number codes, UPC codes and any codes currently in use.

More complex interactive codes could be routed based on any of the scanned information in combination with a cookie, user interactive responses from the user input information, the person's location or other demographic information and a portal server database 210 information. The cookie comprises a person's identifying information such as name, address, credit card(s) information, and other related information. Cookies may be stored on the scanner 100, the receiver 180, or the portal server 200. Other information that may be combined with the code 10 includes executable code downloaded from the portal server 200 or provider 600, and user input information that could further supplement the scanned information from code 10 by eliciting an interactive response from the person using the system.

The user personal profile information supplied depends on the nature of the scan. If all that the user is requesting is freely-available information from web pages, for example, then no more personal information is required than a network delivery address for the web pages being downloaded. Even then, however, the supplier of the information may wish for more information, for example, of a demographic nature. If the user is requesting access to personal or confidential information, or to information for which a fee is payable, or is initiating a commercial transaction, then proper identification is needed. According to an embodiment of the invention, the user enters a PIN number or other identifying data, for example, from a keypad if the scanner 100 or the receiver 180 includes one. According to another embodiment, the scanner 100 is equipped with a biometric device, for example, a fingerprint scanner. According to another embodiment, the scanner 100 and/or the receiver 180 has identifying data embedded or programmed into it, or the network address of the user is identified to the portal server 200. A single device may incorporate features of more than one of those embodiments.

If personal details must be sent over an insecure public network, for example, over the internet or over a cell phone network, then the system preferably includes provision for encrypting the data before transmission. According to one embodiment, a Crypt-all card generates encrypted data and displays it in the form of a machine-readable code 10 that can then be scanned and sent without further encryption.

One exemplary code corresponds to reordering information such that a reordering of a product may be activated by scanning the code 10, recognizing it as a reorder, and maintaining a transaction via the portal server 200 such that a percentage of a fee for the reorder is maintained by a fee tracking module 220. In one embodiment, the fee is shared with the person placing the transaction. In another example, an HMO pharmacy could encode patient information, medication information, and refill information onto a printed label of medication upon its dispensing. The information would be represented by code 10. Scanner 100 would read the code 10 and validate the personal information contained in the code 10 against the user personal profile information stored on either the scanner 100, the receiver 180, the portal server 200, or a provider 600. Once the validation is complete, the system allows for secure transactions to proceed, including authenticated refills, recording the transaction and maintaining an accounting of a percentage of a fee for the refill using the tracking module 220.

A method of the present invention contemplates using additional code types such as phone numbers, business card, service information, benefit redemption information, rebate, coupon, literature, or any general information category of interest to a person or information provider 600. The information contained in the additional code types may be uploaded to the scanner 100, receiver 180, or portal server 200 once or sent locally or with cookie and security information from anywhere in the network. The processing of codes 10, including additional code types, may optionally but not necessarily be done at a time different from reading and scanning the printed medium 50. In a preferred embodiment, the scanner 100 generates and stores a code file in memory 110 representing a collection of codes scanned by the operator in any given time period. The scanner 100 uploads the coded file in memory 110 to the receiver 180 according to a user initiated stimulus. For example, a user may find four advertisements of interest in a printed medium 50, such as a magazine. The scanner 100 could read the four codes 10 from the magazine advertisements and store them in the memory 110. Subsequently, at a time convenient to the user, the user can upload the information to the receiver 180 for processing.

The information in the code 10 could be simple data or complex data-type-plus data, such as encoded, printed multimedia information. A UPC code is an example of simple data. The information used by the system can also be non-coded or raw. For example, a URL is non-coded data, but when encoded as a URL-type code 10, the information in the code 10 may be processed.

A method of the invention uses unique code templates for interactivity which contain transaction information, authorization information, references to the publisher, media originator, ad placement, date of publication, dealer, reseller or distributor. The system is capable of tracking the scans according to the code types used in scanning these ads and collecting the demographics. A method of the invention may also include the steps of tracking and redirecting the usage of the codes 10 by different information providers 600 based on the content of the printed information. For example, a person scans an identifying code 10 related to a brand of computer. The computer manufacturer would like to direct the person to its information site. However, the person who performed the scan or portal server 200 that processed the scan, may choose to auction off the instance of the scan to a competitor, thereby allowing the competitor to bid for the right to transmit more information to the person about the competitor's comparable product or a transaction, such as user interest information.

Another method of the invention includes communicating with digital copyright databases bearing the code in tangible format. For example, an article that includes the code 10 may direct a person wanting to copy the article to the copyright database. The method may include the steps of charging the person a fee and suggesting related articles based on the information in the code 10. The method may also include the steps of monitoring the commercial, office, and copying equipment connected to the network that processes the code, and then activating the access to the copyrighted materials database. In that context, the code serves as an intelligent watermark capable of carrying the article identifying information, distribution information, and fee related information.

Preferably, the code 10 features a small footprint, an attractive appearance, a high density of information, and ease of scanning. For example the footprint may be a triangle shaped code with a logo and an indicator of what type of code 10 it is (information, e-commerce, or both). The identifying characteristics of the presentation of the code 10 signify that the code is not an ordinary advertisement, but part of an enhanced information medium leading to multiple dimensions of multimedia information sequences 500.

The scanner 100 can transmit the code 10 to a receiver 180, such as a television, a set top box, a computer, a cell telephone, a remote control, a personal digital assistant, an integrated PC-TV device (e.g., Web TV), a pager or two-way pager, or directly to the portal server 200. The receiver 180 is in communication with a network, such as the Internet or other network, and can direct or link a person to a specific network address or site based on the machine-readable code or codes 10 contained in the scanned information from the printed medium 50.

For example, the provider information depicted on a printed medium 50 may be advertising information for an automobile. The manufacturer of the automobile would be provider 600. The link information in code 10 from the printed advertisement may include network address information, such as for example the manufacturer's web site. Processing the link information may result in playing a multimedia information sequence 500 on the receiver 180 provided by provider 600. Additionally or in the alternative, the network address information may point to a file containing executable computer code which could be downloaded or executed remotely then displayed on the receiver 180 or scanner 100. One or more link table(s) (not shown) may also be used to facilitate a two-way communication between the provider 600 and receiver 180. A link table containing network codes and associated network address information, for example, may be accessed to process link information containing only the network code. The link table associates the network code to a network address information to facilitate the connection between provider 600 and receiver 180. Link information may also be cascaded via the link table(s). Link tables may be located on or be accessible to the receiver 180, the portal server 200, or the provider 600. The machine-readable code 10 can also link the person directly to a specific Internet address without accessing a link table.

In a preferred embodiment of a system executing a method of the invention, the scanner 100 includes a memory 110, a user interface 120, and a communications bridge 130.

The user interface 120 obtains user input information, such as an advertising authorization, a transaction authorization, a user personal profile information, and a user interest information corresponding to the provider information. The user input information may be received and stored in the scanner memory 110, the receiver 180, or the portal server 200. The scanner 100 routes the link information and the user input information based upon a user request via the user interface 120. The user interface 120 may be, for example, a voice-activated system, a keypad, or a keyboard. In one embodiment, the user interface 120 may reside on any one or more of the scanner 100, the receiver 180, such as a customer premises equipment (“CPE”) 300 for displaying the multimedia sequence information 500, or the portal server 200.

The communications bridge 130 sends the link information and the user input information to the receiver 180 and, via the network, to the portal server 200. An infrared communications system, a mobile radio communications system, or an IP-based communications system are exemplary of the communications bridge.

The scanner 100 comprises a handheld component in a preferred embodiment. The handheld component may comprise an enhanced existing device like a TV remote control, a mouse, a cell phone, a REX device, a palmtop, a calculator, a key chain, a pen, an identification card, a smart card, a hand held global positioning system (“GPS”) device, a desktop or laptop computer or virtually any other digital appliance or a microprocessor based device. The scanner 100 could be a proximity-based device that would activate a smart button, which is a device having a memory and a communicator to upload the information in the memory to a network, or a contact-based device. For example, scanner 100 may be either an optical scanner or a transducer, respectively. The scanner 100 may have several modes, such as scan and process, scan and hold, and scan and display. The scanner 100 may also have a mode allowing copying of the code 10 for backup or review and edit. The scanner 100 may also have a light and/or a sound indicator for confirming that a valid scan occurred. The scanner 100 may also have transmit and receive indicators for confirming that a valid scan occurred. Optionally, the scanner 100 could communicate with another scanner 100 to exchange link, code, or cookie information.

Where the scanner is combined with a GPS device, or other device capable of determining its own location, then that location may be included in the user input information sent to the portal server 200, and may be taken into account by the portal server in selecting the information to be sent to the receiver 180. If the scanner and receiver are installed in a vehicle, then information from a vehicle navigation system may be used. If the scanner 100 and receiver 180, 300 are comparatively immobile, for example, a desktop computer or a domestic television set, then location information may be programmed into the scanner 100, or may be stored in the portal server 200.

If the transmitted scan conveys an enquiry about, for example, the purchase of vendible items such as goods or services, the portal server may supply information about suppliers near to the indicated location of the scanner, and that information may include directions for the user to reach the supplier's location. Such directions could potentially identify even the location of the item on the shelves. The system can also supply the user with information, such as prices, discounts, and special offers, that is specific to the individual supermarket. If there is more than one reasonable supplier, the server may comparison shop, or may auction the enquiry, or may offer the user the choice of suppliers.

If the scanner 100 and receiver 180 are mobile, and the scanner provides location information, then the possibilities for customized information are almost limitless. If a user scans a UPC on a product, and the location of the user is recognized as that of a particular supermarket, say, then the portal server can return to the user Alternatively, information might be provided about competing suppliers in the immediate vicinity.

Instead, the system could order vendibles to be delivered to the user's location. For example, the system could select the nearest cooked food delivery service, or the nearest one that supplied a particular sort of pizza, and generate an order, with at most a confirming telephone call or e-mail message. Where the required product is not locally available, the system can not only locate a supplier, comparison-shopping price and availability as appropriate, but also identify the quickest, cheapest, or most reliable method of delivery to the user's location.

Where suppliers are mobile, for example, in some sorts of health care, emergency repair services, or other service industries where the supplier visits the user's location, the system could also track the movements of supplier units. In one embodiment, a member of supplier personnel uses a scanner 10 to send information on work done to a portal server 200, the scanner sends information including the location of the supplier unit, and that information is used to match user requests to particular mobile supplier units in accordance with optimization criteria.

In one embodiment, the system comprises a shopping comparator module in communication with one or more of the scanner 100, the receiver 180, and the portal server 200. The shopping comparator module is capable of operating or communicating with comparison shopping services and obtaining vendor information based on the link information, including the price information, in a comparative manner. The shopping comparator module is further capable of operating an auction for at least one of the features of link information. An example comprises using system with the shopping comparator module to obtain a best price for a prescription.

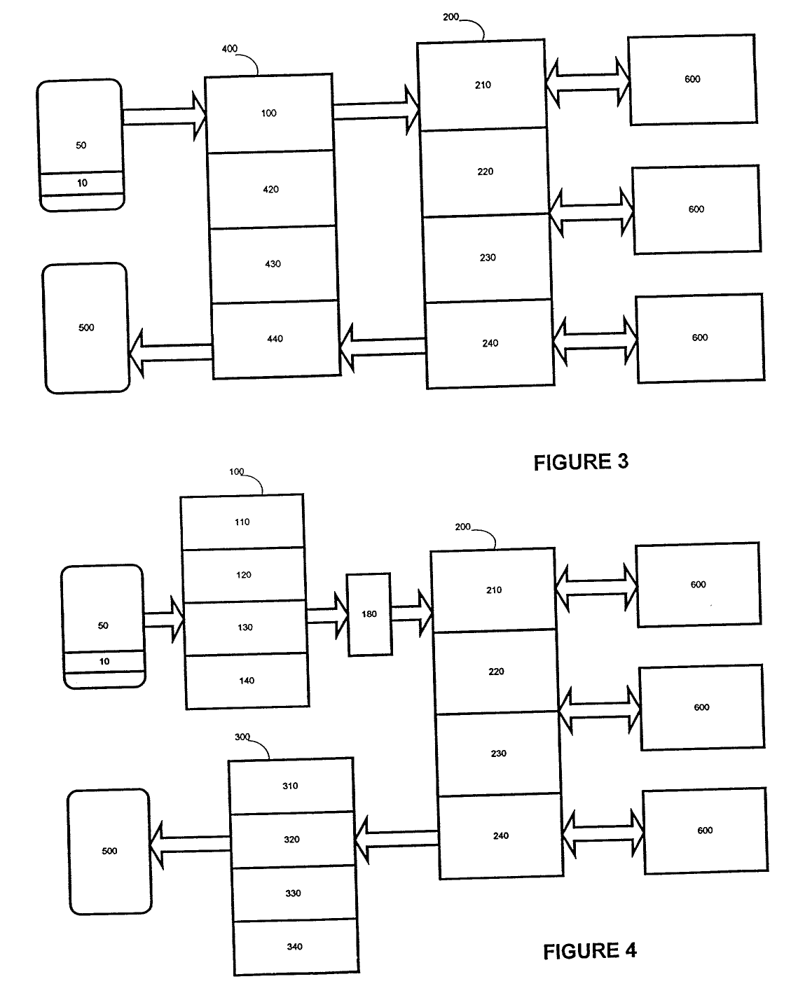

FIG. 3 depicts the scanner 100 as part of an integrated dedicated unit 400 which includes a memory 420, a microprocessor (not shown), stored templates containing the link and cookie information (not shown), a display 430, a cable (not shown), and a wireless transmitting device 440, such as infrared, visual or radio frequency. The dedicated unit 400 could contain any subset of these components or include other components as depicted in FIGS. 2 and 4.

A method of the invention includes the steps of scanning encoded information from the embedded codes 10 and uploading these codes to the portal server 200 for immediate or delayed processing or for reference. A method may also include allowing print advertisers to track their impressions to execution and to collect demographic information about the person performing the scan through a tracking-module 220. The tracking module 220 is illustrated in FIG. 1 as part of the portal server 200. However, it may reside in any of the 100, 180, 400, 300, 200, or 600 components of the system. The tracking module 220 is further capable of tracking the transaction value of e-commerce transactions originating from a specific publication, type of publication, or provider 600 and calculate fee percentages based on the transaction. For example, the scanner 100 may comprise a clock capable of tracking the time the ad was scanned. In an embodiment where scanner 100 is a GPS, the geographical location where the scan occurred may also be tracked. A method of the invention also contemplates transmitting bio-metric information according and to the extent permitted by the user personal profile information. The combination of all tracking information comprises ad read-scan context information which may be transmitted to the portal server 200 or to the provider 600 according to and to the extent permitted by the user personal profile information.

The receiver 180 is in communication with the scanner 100 and portal server 200 via wire, or through wireless technology such as infrared, light based transmission, radio frequency, or satellite. The receiver 180 could be incorporated into or be a computer, a cell phone, a facsimile machine, a pager, a remote control, a personal digital assistant, a simple buffer, or use a direct link. The receiver 180 could also be incorporated into existing devices such as a television, a set top box, a Web TV device, a VCR, a Digital Versatile Disc (“DVD”) player, an appliance, a customer premises equipment (“CPE”) 300, or any other electronic device. The receiver 180 may, but not necessarily, collect, sort and prioritize the transmissions of link and user input information. The receiver 180 could queue up these transmissions or process them immediately. The receiver 180 could also contain at least one cookie, and received time information, as well as other information including receiver or provider specific information.

In one embodiment of a system performing a method of the invention, the receiver 180 forwards the raw scanned codes 10 directly to the portal server 200 or other site such as a provider 600 via a portal server 200. In another embodiment, the receiver 180 collects, stores, processes, and forwards the scanned code information along with the cookie and other state dependant information, such as time, temperature, and location, to the network.

The receiver 180 may be multi-functional and include multiple inputs such as radio frequency and infrared. The receiver 180 may also incorporate X-10, wireless, wired, and power-line networking to link to multiple units or, for larger installations, at least one repeater. The receiver 180 may also incorporate wireless, wire-line, or power-line links to at least one local computer or CPE 300.

In embodiments shown in FIGS. 2 and 4, the CPE 300 may function as a queue processor or pre-processor. Also a user may enter information using the CPE 300, including user personal profile information. In another embodiment, scanned codes 10 are processed by the CPE 300 according to user preferences. By way of example, the CPE 300 could process the codes 10 automatically and sequentially as the codes 10 are received, or store the codes 10 in a queue to be processed at the convenience of the user. Cookies may be stored on one or more of the CPE 300, the scanner 100, and the receiver 180. The CPE 300 receives the scanned code 10, including the link information from scanner 100, and transmits the code 10 to the portal server 200. The portal server 200 resolves the link information and sets up a path from a location on the network, such as a specific web address, Internet site, or provider 600 location, to the receiver 180. The location sends information, such as multimedia information sequences 500, along the path to the receiver 180 for display and playback.

A system for performing a method of the present invention contemplates at least one portal server 200. The portal server 200 may be a single site or multiple sites. The portal server 200 is in communication with the scanner 100 and the receiver 180 via the network and centrally manages, assigns, and controls the codes 10, code types and information from the printed media 50. The portal server 200 is capable of receiving the link information and the user input information, selecting a multimedia information sequence 500 corresponding to the link information and the user input information, and sending the multimedia information sequence 500 via the network to the receiver 180.

One embodiment of the portal server 200 is capable of maintaining a scanner abstraction layer, with published API's. It then becomes possible for providers to write modular applications that interface with the incoming data from scanners 100 at the published interface. Each module registers with the server system an interest in processing particular sorts of scans. The system assesses incoming scan data, and relays it to one or more modules according to the interests registered. The scan data may contain a portion of data intelligible only to the appropriate modules, provided that that portion of data is packaged so that the system does not need to understand it, and provided that the standard part of the scan data contains sufficient information to ensure that the data reaches only the correct modules.

Modules may function for information gathering, requests, transmission, logging, and other tracking and transaction oriented functions. The common system monitors the activity of the various modules, and apportions costs and revenues to the providers. Such an open, modular structure is believed to be especially advantageous, because specialized modules, and modules for new functionality, are written more readily and more quickly under free-market conditions.

One advantage of the method of the invention is the minimal amount of information needed to be scanned to link to a specific location when using a link information database including cookies at the portal server 200. The portal server 200 processes code 10 which may contain levels of embedded information, and references information, such as database information provided by providers 600, advertisers, and information providers. The information contained in scanned code may be combined with at least one of the user input information, the cookie, state dependant information, ad read-scan context information and other transmitted information to link the portal server 200 to at least one location on the network and complete a transaction, such as a request for information or an e-commerce transaction.

In one embodiment of a system performing a method of the invention, the portal server 200 is adapted to receive and process requests from a user who provides the portal server 200 with raw code 10 through a communications device such as a keyboard, a telephone, a voice activated system, or a modem. In this embodiment, a user can initiate the interactive communication of multimedia information without using scanner 100. In a further embodiment, the scanner 100 may access the portal server via a telephone dial system. For example, after scanning, a user may use a telephone to communicate the scanner 100 to the network. The scanner 100 may then be a simple light-pen, connected to the telephone through circuitry transparent to the user. The system can then be used by persons with no experience of using, or desire to use, a computer or other information technology devices.

Once data has been transferred, the user may use a voice menu system to control the remainder of the transaction, such as the receipt of sound only information, or engaging in a transaction. Instead of, or in addition to, the voice menu system, the user could be connected to a call center with human operatives, who would be have displayed all of the information from the original scan. A certain amount of user identification information could also be automatically supplied to the operatives.

In another embodiment, the receiver is a facsimile machine, and can receive data from the server in the form of computer-generated fax images. The fax images could include machine readable codes 10, which could be scanned by the user to supply or request further information. A dialog between the user and the portal server could then be conducted entirely by facsimile and light pen.

In another embodiment, the portal server 200 has a single common database of links for print and electronic transactions. The database of links may be accessed by users of the system, such as advertisers, print media owners, and information providers 600.

A tracking module 220 in the portal server 200 can track link information corresponding to a user, such as a universal resource locator, an Internet address information, a trademark information, a source of origin, an organization name, a product name, a service name, a benefit redemption information, a provider defined information, a user personal profile information, a user interest information, a server command information, and a customer premises equipment preference information.

The tracking module 220 is also capable of tracking fees associated with every ad and every transaction originating on the network via the portal server 200. Fees may be based on, for example, the selected multimedia information sequence, the number and frequency of the link information received by the portal server corresponding to a particular information provider, or the transaction value in the event the selected multimedia information sequence generates a transaction. The fee tracking module 220 can track fees relating to at least one e-commerce transaction originating from the scan.

A provider management module 230 and a statistics module 240 in the portal server 200 maintain advertising information and transactions generated from the providers 600 that originate independent of a scan based on user personal profile information. Thus, the invention allows advertisers to broadcast to users of the portal server 200 according to the user personal profile information or portal server configuration. The provider management module 230 is capable of providing feed back to the providers regarding the effectiveness of the provider's printed media 50, and allows for flexible, real-time message tuning.

An individual demographics (“indigraphics”) module (not shown) in the portal server 200 performs user personal profile information management functions, such as marking and publishing auction oriented information based on the user personal profile and interest information. The user personal profile information can also be used to modify the selection of information that is supplied in response to subsequent user scans.

A funds management module (not shown) in the portal server 200 manages and facilitates fund transactions between users of the system. The funds management module processes information from the other modules in the portal server 200, such as the tracking module 220. Preferably, the funds management module uses a form of electronic funds transfer, such as Ecash, to accept and distribute funds according to information received form the tracking module 220.

For example, in a system capable of performing a method of the invention, a person can scan an ordinary black and white automobile advertisement placed in a newspaper by a local dealer that is enhanced with code 10. Shortly thereafter, the person experiences a full-featured multimedia presentation related to the advertisement on the person's Web TV or computer. The indigraphics module enables the presentation to be tailored to the individual viewer. As is possible with any of the information sequences produced by the methods and systems of the present invention, the server 200 maintains a plethora of links to different stored multimedia display elements, and creates the presentation in real time by selecting and combining elements in accordance with the scanned-in enquiry and the user's individual demographics. The portal server 200 may either transmit the completed presentation to the receiver 180 or, if the receiver is sufficiently powerful, may merely transmit the sequence of links from which the receiver can call down and assemble the elements of the presentation.

The tracking module 220 calculates a fee to be shared between the manufacturer, the dealer, and the person buying the car based on a percentage of the sale. The funds management module can accept Ecash from the person and either distribute it to all parties involved in the transaction or store the information as debits and credits in an account database.

In another example, a person can go to the grocery store and scan UPC codes 10 off items and check the nutrition information or recipes at the end of the aisle in a kiosk with or without a printer. Alternatively, the person can take the UPC information home and upload it to their receiver 180 or a CPE, and get information on the product, a coupon, or other benefit redemption information. The store could optionally provide a link to the net so the user could upload the information to his home computer from the store via the Internet connection.

In another example, stuffed animals could be linked to a location on the network by using a scanner 100. The scanner 100, according to this example can be a proximity-based device, such as a smart button (like those in Java rings), or almost any other kind of device including security cards and access devices.

In another example, a person can scan a 5 year old computer monitor on the person's desk and be immediately routed to a web page that offers a list of local service centers for the monitor or technical information about the monitor, such as schematics, instruction manuals, or warranty manuals. The transaction could also result in the person receiving a rebate offer, a trade-in offer, or recall and safety information. The invention enables manufacturers to maintain contact with customers for extended periods of time beyond the traditional period of time manufacturers and customers interact. The contact enables the manufacturer to collect product usage information that was traditionally inaccessible. Manufacturers could also use incentive programs to get people to scan their products.

The invention provides a method for allowing the information providers 600 to electronically receive codes 10 to embed in the advertisements. It also allows the publishers of the advertisements, such as newspaper and magazine companies, to print their own ad codes and share this information with the portal server 200. The invention contemplates using an enhanced code in the ads containing information on the identity of the publication and the product and enables the publishers of the ads to share in the flow-through profits of a transaction even though they may not provide any products. The invention further enables simple marketers and catalogue providers to operate with reduced infrastructure by including information in the code 10 which points to portal-operated e-commerce stores or to the manufacturer/distributor's e-commerce store. The method also enables advertisers to record the level of response to different advertisements, both in terms of enquiries generated and in terms of e-sales generated. The advertiser can thus measure directly the effectiveness of different advertisements in different printed media.

Reprints of copyrighted material could also be a service the portal server 200 provides to authors. Authors may embed a code 10 in their book or article. A user scanning the code 10 could receive a copy of the entire article or related articles or books or information for an appropriate fee. The invention provides authors with an inexpensive method for collecting fees that are typically very small. A copyright service portal server could credit the author's account by pennies or even fractions of pennies per downloaded page via an existing e-commerce service or another portal server. Fees associated with accessing and downloading moderately and expensively priced items, such as CDs and newsletters, can be handled in a similar fashion.

The invention further contemplates setting up medical testing devices to operate with the system. A body monitor capable of tracking medical information regarding the person's then existing medical condition could communicate this information periodically or when a parameter is so indicated or satisfied. The system of the invention features the ability to combine wired and wireless raw data with user input, state information, and cookie information, at the portal server 200. The portal server 200 directs and channels the information based on the user personal profile information. The base information could be a code that is scanned or is embedded in a device that adds the base information to information collected by the body monitor. The link at the portal server 200 may be dynamically moved and a new version of the body monitor's embedded code or a new set of parameters may be downloaded from a location on the network.

The invention also contemplates using the system to collect alarm and appliance information from household items. The system includes a central receiver capable of receiving radio frequency or infrared signals. A raw data stream, pointer information, and state information may be transmitted from the household item to the receiver. The receiver communicates the information to the portal server. The portal server can combine the information with a cookie and use the pointer information to securely send it to the manufacturer's web site.

The invention contemplates using the system for a wide variety of purposes. For example, parents and a school could use codes 10 and scanners 100 to monitor the arrival and departure of children, or parents could scan a child's report card to confirm that they had read it. A fitness club could provide placards with bar codes on them for users to scan to record their weight, exercises completed, and so on. Once the data was uploaded, an application module on the server could recognize the data, generate any desired form of report, and return it to a receiver 180 comprising a printer for printing out. The system could be used for stock control. Every time the user uses an item, he or she scans the UPC code. A module on the server 200 can then log the consumption of items from stock, which might be items in a factory, a shop, or even groceries in the user's kitchen at home, generate orders for replenishment of items that are running short, and even identify patterns and predict when replenishment of particular items will be needed.

The system executing a method of the invention may have several modes of operation, including collect and store, collect and execute, and collect and process then execute. The user sets the mode according to the user personal profile information. The user interface of the scanner, settings on the receiver and software settings on the CPE 300 or the portal server 200 may also be combined with the user personal profile information to set the mode.

Existing remote control devices such as television remote controls can be modified to scan and transmit the code 10 to a receiver 180 such as a set top box. In one embodiment, the code 10 would be scanned and embedded after a specific sequence of standard codes that could be stripped out by the receiver 180. For example, in collect and store mode, pressing a predetermined sequence of buttons on a remote control will activate the scan mode of the remote. Once activated, the remote control can be used to collect and store a code 10 from a magazine advertisement, for example. The user would then point the remote at the set top box and depress a single key or sequence of keys to transmit the code information.

Information such as multi-media information sequences 500, may be transmitted to a CPE 300, or any other receiver 180 connected to the network. The receiver 180 and a local CPE 300 could be combined into a single unit. The receiver 180 could be a dumb or smart device, embedded or stand alone. The CPE could be a PC or could be omitted or replaced by online processing or by a Web TV. The receiver 180 and scanner 100 of the invention can be combined and included as part of an enhanced WebTV.

In one embodiment of the invention, a machine-readable code 10 contains not merely a link to or identification of a source of information on a network but the actual text of a document. For example, a document sent by facsimile may contain either a machine-readable code 10 providing a link to a machine-readable version of the faxed message, or an actual copy of the text in high-density machine-readable code so that a scanner 100 can read it. For another example, a printed publication could contain its own text in high-density machine readable code 10. Thus, in either case, the document can be provided in word-processor format for further editing, without the need for a direct computer-to-computer connection. Alternatively, the entire text of a document could be printed in a space too small to contain it in normal print, and scanned into a scanner 100 and receiver 180. The scanner 100 then need only have sufficient memory to store the scanned document, and some means of displaying it. Even a scanner incorporated in a pager could be used. In accordance with this embodiment of the invention, it is possible to print a resume on the back of a business card, or to have a medical card that bears a complete medical history.

This embodiment is especially advantageous for backing up of data. It is merely necessary to connect a device 100, 180, 300 to a printer (not shown) and to print out the contents in high-density machine readable code. Connecting the device to the printer by means of an infra-red or radio link is especially preferred. The code may be either a straight dump of the memory content of the device being backed up, or a higher-level code that is not machine-specific. A code 10 that is not machine specific may also be used to transfer data from one device to another, when a direct electronic link is unavailable or inconvenient. For example, an address book telephone list could be printed out from a computer contact manager, and the entire list, or a particular number that the user wishes to dial, scanned into a telephone equipped with a scanner 100.

A portal server 200 could also update information on a device to which it is not directly connected by sending a machine-readable code 10 to a printer from which the printed code is sent to the scanner of the device that is to be updated.

The system is further capable of printing a machine readable code 10 which may update calendar or schedule information on a customer's PIM or contacts, where the PIM is equipped with a scanner 100. The machine-readable code 10 may either be a high density code containing the actual schedule information being sent, or a link information, including a pointer, to a link table or a page containing the necessary update file. This system comprises a different way of hot loading a PIM with current information. It also bypasses docking and other physical connections, and the machine-readable code 10 could be faxed or copied.

Another embodiment of the invention is be used with television and movie program guides and catalogs. The guide includes machine-readable codes 10 that give scheduling information. The user selects a program or a film, and scans the associated code. The system then programs the video recorder, generates a pay-per-view order, sets the television set to the correct channel, or takes whatever other action is required. The processing may be assigned to the scanner, the portal server, or the receiver as is appropriate in a particular case. This embodiment has the advantage that, if the need for keypad input can be eliminated, the size of a television or VCR remote control unit can be considerably reduced. The codes used may correspond to the existing VCR Plus codes, or may contain additional information, such as information about the content of programs.

The system may further comprise a digital content distribution module in communication with the scanner 100. The scanner 100 may be in communication with an MP3 player device (e.g. RIO) or a similar digital content player device (not shown), including an MPEG2 video content player. The digital content distribution module may be activated with a scan of a machine-readable code 10 in an advertisement or similar printed medium, so that the scan causes downloading of the complete video file or just a sample clip.

According to another embodiment of the invention, printed receipts, invoices, statements, and other records of transactions include a machine-readable code 10 that either contains the details of the transactions or provides a link to a database accessible from the network that contains the transaction details. The user can then simply scan the code, and the transaction data are fed directly into an expense tracking or expense analysis package, billing system, or the like. If the code 10 links the user to the other party's database, then charges can be disputed, or paid by electronic fund transfer, a quotation can be approved, and so on. It will still usually be necessary to require the user to input some identification, such as a PIN, but most of the procedural steps involved in accessing such databases online can be bypassed by the code 10 which points directly to the specific supplier, user account, and records. Of course, depending on the power of the scanner 100 and receiver 180, the user may be linked directly to the required database, or to a portal server 200 that identifies the correct database and then supplies the necessary further link. Where the portal server 200 hosts a multiplicity of supplier modules, those modules may include modules that recognize particular sorts of transaction.

The transaction records may also include warranty registration and maintenance contract registration details for a newly-purchased product, so that the 10 user, simply by scanning in a single code 10 applied or attached to the product or on the associated paperwork, and appending personal details if those are not already stored in the scanner 100, can download the purchase details for accounting purposes, register for warranty support, register or invite a quotation for a maintenance contract, register for notification of upgrades, or any combination of those actions.

According to another embodiment, a business card (not shown) bears a machine-readable code 10 that links to an on-line version of the business card. By scanning the code 10, a user can automatically register with the on-line business card. Then, if any of the contact details on the business card change, registered users can be automatically notified of the change. The owner of the business card may send a change to all registered users, or may select only some users to be notified. The owner may, of course, delete from the database of registered users any who are no longer of interest or whose details are believed no longer to be correct. Such deletions may be carried out either from time to time or in a batch before a change in the business card is broadcast. It is also possible for the owner of the business card to include other services with the registered users of the business card, so that an address change is automatically registered with, for example, the postal service and the Publishers' Clearing House for re-direction of mail.

One embodiment of a scanner 100 of the present invention comprises a scanning laser beam, preferably in combination with a device for sensing variations in the intensity of the reflected light, for reading codes 10, typically in the form of black and white markings on a two-dimensional medium. In accordance with the invention, the intensity of the laser beam can be modulated in synchrony with scanning of the beam in two dimensions so as to project a visible image onto a surface. The projection surface may be part of a visor or helmet, or may be a convenient external surface such as a wall. The image may be generated within the scanner 100 from a code 10 that is scanned in, or may be received from a portal server 200.

In an embodiment of the invention, a user purchases or leases the use of a number of scan codes 10 from the operator of a portal server 200, or from a provider running a module on a portal server. The user may then use those codes for his or her own purposes, for example, for recording and tracking documents or asset or inventory management. The codes may be totally unique, or may be unique only in combination with the user's “cookie” or other distinguishing data.

In one embodiment, the system comprises a preference tracking module (not shown) for tracking actions taken by users of the system. The preference tracking module may be in communication with, or may be incorporated in, any of the scanner 100, the receiver 180, or the portal server 200. The preference tracking module may track one or more of the user input information, the multimedia sequence information corresponding to the user input information, and transactions generated based on the user input information. The preference tracking module may be used to direct a purchase or an information request based on purchasing patterns derived from prior purchases and requests. The system will thus be capable of facilitating transactions with vendors whom a consumer has previously dealt with or indicated a preference for via previous purchasing patterns.

In one embodiment, the system comprises a results page module (not shown) in communication with, or incorporated in, any one of the scanner 100, the receiver 180, and the portal server 200. The results page module is capable of arranging the link information and the user input according to the user's preferences or according to the type of information. For example, the link information may correspond to 10 information requests in no particular order comprising 5 requests relating to books, 3 requests relating to wines, and 2 purchase requests for business related publications. The results page module is capable of organizing the requests and the subsequent corresponding multimedia information sequence presentations according to type, e.g. books, wines, publications. The results page module is further capable of organizing the corresponding multimedia information according to the user preferences obtained from the preference tracking module. An embodiment of the system may work with an existing portal site (e.g. Hotmail or Yahoo) which may process the link information from the scanner 100. A customer may open up a queue to a mail message and the portal may process the link information (i.e. scans) and may generate a new mail message via the results page module.

In one embodiment of a system for performing a method of the invention, the system enables initiating a communication from a printed medium containing provider information across a network, the system comprising: a scanner for receiving data from the printed medium, the data comprising link information corresponding to the provider information, the scanner comprising a memory; a user interface for receiving user input information, the user input information capable of being stored in the memory; and a communications bridge in communication with the network; a receiver in communication with the scanner, the receiver capable of receiving and communicating the link information and the user input information via the network and receiving and playing a multimedia information sequence; and a portal server in communication with the scanner and with the receiver via the network, the portal server capable of receiving the link information and the user input information, selecting the multimedia information sequence corresponding to the link information and the user input information, and transmitting the multimedia information sequence via the network to the receiver.

The data may be machine-readable code. The machine-readable code may be a barcode, an enhanced barcode, a new enhanced code, a dynamic code, and or a high-density barcode. The machine-readable code may further comprise publication information or personal security information or a provider security information. At least one machine-readable code may be stored in a code file. The code file may be stored in the scanner memory.

The link information may be a universal resource locator, an Internet address information, a trademark information, a source of origin, an organization name, a product name, a service name, a benefit redemption information, a provider defined information, a user personal profile information, a user interest information, a server command information, a customer premises equipment preference information, and an alphanumeric sequence printed in form of a machine-readable code.

The alphanumeric sequence may be assigned by a provider of the provider information. The provider information may be extracted from the alphanumeric sequence and translated into a network address at the portal server. The system may also comprise a link table capable of translating the alphanumeric sequence into a network address. The alphanumeric sequence may be one of a UPC or an ISBN number.

The system may further comprise a plurality of link information. The scanner and receiver may be combined into a single unit. The scanner may be further capable of routing the link information and the user input information to the network in response to a user request via the user interface.

The communications bridge may be capable of sending the link information and/or the user input information to the receiver or the portal server.

The scanner may be a hand-held device. The hand-held device may be wireless. The portal server may be accessible via the network to a network user and/or accessible exclusively by a provider of information. The user input information may comprise one or more of a user personal profile information, or a user interest information. The scanner may be capable of storing a plurality of data. The user input information may be selected from the group consisting of an advertising authorization, a transaction authorization, and a user personal profile information. The scanner may be a remote control, a mouse, a cellular telephone, a pager, a personal digital assistant, or a personal computer.

The user interface may be a voice activated system, a keypad, or a keyboard. The communications bridge may be either of an infrared communications system, a mobile radio communications system, or an IP-based communications system. The network may be the Internet, an Intranet, or an Extranet.

The scanner may be an enhanced existing electronic device, a TV remote control, a mouse, a cell phone, a pager, a PC card device, a palmtop, a calculator, a key chain, a pen, an identification card, a smart card, a hand held GPS device, a desktop or laptop computer, a digital appliance, or a microprocessor-based device.

The portal server may further comprise a tracking module capable of tracking the link information corresponding to the user and a percentage of a fee to be charged to the information provider. The fee may be based on at least one of the selected multimedia information sequence, a number and frequency of the link information received by the portal server corresponding to a particular information provider, or a transaction value when the selected multimedia information sequence generates a transaction.

The multimedia information sequence may be advertising or transaction information. The user input information may further comprise a user personal profile information.

The portal server may be further capable of tracking a percentage of a fee to be charged to the information provider based on the selected multimedia information sequence and the user personal profile information.

The user input information may comprise at least one user interest information. The portal server may further be capable of auctioning the user interest information to an information provider according to a user defined auction criteria in the user personal profile information. The user personal profile information may be stored on the portal server.

The portal server may be further capable of tracking a percentage of a fee to be charged to the information provider based on the selected multimedia information sequence and the user interest information. The scanner and the customer premise equipment device may embody a single device. The customer premises equipment may be either of a television, a set top box, a computer, a cell telephone, a remote control, a personal digital assistant, an integrated PC-TV device, or a pager. The multimedia sequence information may be one or more of textual, audio, or video information.

The system may further comprise a receiver in communication with the communications bridge. The machine-readable code may change dynamically. The tracking module may be located in either of the scanner, the receiver, or the portal server.

In a preferred embodiment, the tracking module is capable of tracking one or more of the link information, the user input information, a percentage of a fee to be paid back to a user of the system and to a manager of the portal server, according to the user personal profile information.

The portal server may further comprise a provider management module for controlling the duration and frequency of multimedia sequence information independent of scan generated transactions and for billing the information provider a fee for presenting the multimedia sequence information.

The scanner may maintain a clock for synchronizing scan related information which may be transmitted along with the user input information. Either of the scanner, the receiver, or the portal server may maintain a provider management module capable of: controlling the multimedia sequence information; tracking the duration and frequency of the displayed multimedia information as part of the sequence at the receiver, wherein the sequence is in part provided by an information provider via the network; billing the information provider a fee for displaying the provided multimedia information as part of the sequence; and tracking a percentage of the fee which will be paid back to an owner of the receiver.

The system may further comprise an interactivity feature for selectively accessing the multimedia sequence information by a user at any time via an interactivity button of the scanner. The interactivity feature may be capable of accessing an application as part of the sequence provided by an information provider to maintain a transaction between a user and the information provider.

The portal server may be capable of controlling one or more of the transaction, a number of transactions between the user and the information provider and a number of interactions between the user and the information provider. The portal server may be further capable of billing the information provider a fee for maintaining either of the controlled number of transactions or the controlled number the interactions. The portal server may be further capable of tracking a percentage of the fee which will be paid back to an owner of the scanner. The transaction may be either of catalog shopping or a purchase.

The link information may include a network address information (e.g. an IP address). The network address information may point to a file containing executable code. Any one or more of the scanner, the receiver, or the portal server may contain at least one link table. Any one or more of the scanner, the receiver, or the portal server may contain additional information or downloaded executable code and intelligence that could supplement the code with an interactive response of the person using the system. The additional information may comprise the person's identifying information, name, address, credit card(s) information, and related information.

The code may further be capable of containing personal information and reorder information printed by the provider, whereby the personal information is validated against the user personal profile information before a reorder or another transaction is allowed to proceed. The code may be an information-only type capable of linking to an information page. The code may be a universal product code (UPC). The code may be routed based on any of the scanned information in combination with the cookie information, the person's interactive responses from the user input information, the person's location or other demographic information and the portal server database information. The code may be a reorder code, whereby reordering of a product may be activated by scanning the code, recognizing it as the reorder code, and maintaining a transaction via the portal server such that a percentage of a fee for the reorder is maintained by a tracking module. The tracking module may also maintain a percentage of a fee corresponding to revenue sharing with the person originating the transaction.

The code types may include a phone number, a business card, service information, benefit redemption information, a rebate, a coupon, a literature, or general information category of interest to a person or information provider. The code may be uploaded to either of the scanner, the receiver, or the portal server once or alternatively may be sent locally or with cookie and security information from anywhere in the network.

The processing of the collected codes may be done at a time different from reading and scanning the printed medium. The code may be a UPC code, whereby the user is directed to a provider via the link table without any additional codes. One or more of the scanner, the receiver, or the portal server may maintain code templates for interactivity, transaction information, authorization information, references to the publisher, media originator, ad placement, date of publication, dealer, reseller or distributor. One or more of these elements may further maintain a tracking module working in conjunction with a statistics module collecting the scanned information on the basis of code types used in scanning the provider information and collecting demographic information relating to the user personal profile information, link information, and user input information. The tracking module may be capable of tracking, redirecting, and targeting usage of the codes by different information providers based on the content of the printed information.

A person using the system may choose to publish the fact of the scan, thereby allowing a competitor to bid for the right to display to the person more information about the competitor's comparable product or a transaction, based upon the user interest information.

The system may be in communication with at least one digital copyright database corresponding to physical published products bearing the code in tangible format, whereby the scan directs a person wanting to copy the published product to the copyright database via the portal server, and the portal server tracks fees based on the copy and is capable of suggesting topically related published products. The portal server may also be capable of monitoring xerographic equipment connected to the network for the processing of the code, which then activates the access to the copyrighted materials database. The code may be an intelligent watermark capable of carrying identifying, distribution, and fee related information on a physical published product.

Any one or more of the scanner, the receiver, the portal server, or the provider may be capable of allowing either the information provider or an owner-publisher of printed medium to track scanned printed medium impressions to execution and to collect demographic information according to the user personal profile information. This tracking feature may track the percentage of e-commerce transactions originating from a specific publication, provider, or specific type of publication. The tracking feature may further track the percentage of a fee to be paid back to the owner-publisher of the printed medium based on the number of impressions.

The receiver may be a customer premises equipment, a computer, a simple buffer, a direct link, a television, a cell-phone, a pager, a set top box, a PC-TV device, a VCR, a DVD player, an appliance, or any other electronic device.

The portal server may comprise one or multiple sites where the processing of the codes takes place. The portal server may allow central management, assignment, and control of the codes and code types and provider information. The portal server may allow advertisers to the portal server, print media owners, and information providers to have a single common database of links for print and electronic transactions. The portal server may maintain a fee tracking module for tracking charges based on an ad or a transaction originating on the network via the portal server. The fee tracking module may also track fees relating to e-commerce transactions originating from the scan.

The portal server may further maintain a provider management module and a statistics module for tracking and maintaining advertising and transactions generated from the providers but originating independent of a scan, based on user personal profile information.

The system may enable the advertisers to broadcast provider information to the portal server users according to the user personal profile information or general portal configuration.

The provider management module may be capable of providing feed-back to the information providers regarding the effectiveness of the provider printed information, and allowing for flexible, real-time message tuning. The portal server may further maintain an indigraphics module for providing the user personal profile information management functions and for publishing auction-oriented information based on the user personal profile and user interest information. The indigraphics module may operate in conjunction with a bid tracking module collecting the user personal profile information corresponding to bidding users who scanned or expressed interest via the user interest information, whereby the bid tracking module tracks bids placed by bidding users according to published auction information and tracks a percentage of a fee to be paid back to the publisher of the auction information and a media publisher who printed, published, or originated the bid.

The portal server may maintain a code management module allowing the information providers to electronically set and maintain codes, and the corresponding link information.

The code management module may allow the media providers to create and print their own codes and share the code information with the portal server. One or more of the scanner, the receiver, and the portal server in the system may maintain the ability to dynamically change the link or a link table at the portal and to effect a download of a new version of a code or a new set of templates or a new link. The machine-readable code may be a universal product code (UPC) or an ISBN code. The portal server may be capable of selecting the multimedia sequence information based on the link information containing any one or more of a producer name, a distributor name, or a product name, and based on a provider preference link accessible to the provider.

The invention further contemplates a method for communicating multimedia information via a network connecting a scanner, a portal server, and a customer premises equipment, wherein the communication is activated via a printed medium, the method comprising the steps of: scanning a machine-readable code containing a link information corresponding to a provider information from the printed medium using a scanner; storing the machine-readable code in a memory; extracting the link information from the machine readable code in the memory; obtaining and storing a user input information corresponding to the provider information in the memory; sending the link information and the user input information to the portal server via the network; receiving the link information and the user input information at the portal server; selecting a multimedia information sequence corresponding to the link information and the user input information; sending the multimedia information sequence to the receiver via the network; receiving and storing the multimedia information sequence at the receiver; and playing the multimedia information sequence via the receiver.

In an embodiment, the invention comprises a method for communicating multimedia information via a network, wherein the communication is activated via a printed medium, a system for performing the method comprising: a scanner for machine-readable code containing a link information corresponding to a provider information depicted on the printed medium, the scanner being connected to the network, the scanner containing a memory; a user interface for obtaining user input information capable of being stored in the memory, the user input information corresponding to the provider information; a communications bridge for sending the link information and the user input information via the network; a portal server in communication with the scanner via the network, the portal server capable of receiving the link information and the user input information; selecting a multimedia information sequence corresponding to the link information and the user input information; and sending the multimedia information sequence via the network; and a customer premises equipment in communication with the portal server, the customer premises equipment capable of receiving the multimedia information sequence and playing the multimedia information sequence.

In another embodiment, the invention comprises a method for communicating multimedia information via a network, wherein the communication is activated via a printed medium, a system for performing the method comprising: a user device capable of connecting to the network, the user device containing a scanner and a storage device for machine-readable code containing a link information corresponding to a provider information depicted on the printed medium; a user interface for obtaining user input information capable of being stored in the storage device, the user input information corresponding to the provider information; a communications bridge for sending the link information and the user input information via the network; a display device for receiving multimedia information sequence and playing the multimedia information sequence; and a portal server in communication with the user device via the network, the portal server capable of receiving the link information and the user input information, selecting a multimedia information sequence corresponding to the link information and the user input information, and sending the multimedia information sequence via the network.

In yet another embodiment, the invention comprises a method for communicating multimedia information via a network, wherein the communication is activated via a tangible medium, a system for performing the method comprising: a user device capable of connecting to the network, the user device containing a transducer and a storage device for machine-readable code containing a link information corresponding to a provider information depicted on the printed medium; a user interface for obtaining user input information capable of being stored in the storage device, the user input information corresponding to the provider information; a communications bridge for sending the link information and the user input information via the network; a display device for receiving multimedia information sequence and playing the multimedia information sequence; and a portal server in communication with the user device via the network, the portal server capable of receiving the link information and the user input information, selecting a multimedia information sequence corresponding to the link information and the user input information, and sending the multimedia information sequence via the network.

In this embodiment of the system, the user device may be either of a proximity-based device capable of activating a smart button or a contact-based device.

In another embodiment, the invention comprises a method for managing a domain name service based on initiating a communication from an object containing provider information via a network, such as the Internet, an intranet, or an extranet, which connects a scanner, a portal server, and a receiver. The method involves scanning a machine-readable code containing a link information corresponding to the provider information from the object using the scanner and storing the machine-readable code in a memory. The link information is then extracted from the machine readable code in the memory. A user input information corresponding to the provider information is also obtained and stored in the memory. The link information and the user input information are then sent to the portal server via the network. The portal server receives the link information and user input information and selects a multimedia information sequence corresponding to the link information and the user input information. The multimedia information sequence is then sent to the receiver via the network. The receiver receives and stores the multimedia information sequence plays the sequence automatically or in response to a stimulus, such as a user request.

In one embodiment of a system executing a method of the invention, the scanner and the receiver comprises a single device. In another embodiment, the scanner communicates with the portal server directly, and customer premises equipment (“CPE”), serving as the receiver, plays multimedia sequence information received from the portal server. In a further embodiment, the CPE operates as both a scanner and a receiver. The multimedia sequence information may be advertising or transaction information and may contain one or more of textual, audio, or video information.

In a preferred embodiment of a system executing a method of the invention, the scanner includes a memory, a user interface, and a communications bridge. The scanner may be, for example, a remote control, a mouse, a cellular telephone, a personal digital assistant, a personal computer, a pager, or a two-way pager. The scanner detects and reads data, such as machine-readable codes containing link information corresponding to provider information from the printed medium. A plurality of codes may be stored in the scanner, the receiver, and the portal server. The link information corresponding to the provider information may include, for example, a universal resource locator, an Internet address information, trademark information, a source of origin, an organization name, a product name, a service name, benefit redemption information, provider defined information, user personal profile information, user interest information, server command information, and customer premises equipment preference information.

The user interface obtains user input information, such as an advertising authorization, a transaction authorization, user personal profile information, and user interest information corresponding to the provider information. The user input information may be received and stored by either the scanner, the receiver, or the portal server. The scanner routes the link information and the user input information based upon a user request via the user interface. The user interface may be, for example, a voice-activated system, a keypad, or a keyboard. In one embodiment of a system executing a method of the invention, the user interface may reside on any one or more of the scanner, the receiver, such as customer premises equipment for displaying the multimedia sequence information, or the portal server.

The communications bridge sends the link information and the user input information to the receiver and, via the network, to the portal server. An infrared communications system, a mobile radio communications system, or an IP-based communications system are exemplary of the communications bridge.

The portal server is in communication with the scanner or the receiver via the network. In one embodiment of a system executing a method of the invention, the portal server is accessible via the Internet to any Internet user. In another embodiment, the portal server is accessible only by the provider of information. The portal server is capable of receiving the link information and the user input information, selecting a multimedia information sequence corresponding to the link information and the user input information, and sending the multimedia information sequence via the network to the receiver. The portal server is further capable of tracking link information corresponding to a user, including a universal resource locator, Internet address information, a trademark information, a source of origin, an organization name, a product name, a service name, a benefit redemption information, a provider defined information, a user personal profile information, a user interest information, a server command information, and a customer premises equipment preference information.

In a preferred embodiment of a system executing a method of the invention, the portal server is further capable of tracking a percentage of a fee to be charged to the information provider based on, for example, the selected multimedia information sequence, the number and frequency of the link information received by the portal server corresponding to a particular information provider, or the transaction value in the event the selected multimedia information sequence generates a transaction.

In another embodiment of a system executing a method of the invention, the portal server is further capable of tracking a percentage of a fee to be charged to the information provider based on, for example, the selected multimedia information sequence and either of the user personal profile information or the user interest information. The portal server is further capable of auctioning the user interest information according to a user defined auction criteria in the user personal profile information to an information provider. The user personal profile information may be stored on the portal server.

The receiver is in communication with the scanner and the portal server, and is capable of receiving the link and user input information, receiving a multimedia information sequence, and playing the multimedia information sequence. The receiver may be a CPE, such as a television, a set top box, a computer, a cell telephone, a remote control, a personal digital assistant, an integrated PC-TV device (e.g. Web TV) or a pager.

A system executing a method of the invention may further comprise a code tracking module for tracking ranges of unique codes which can (but do not necessarily have to include) one or more of embedded template calls for interactivity, references to the publisher, media originator, ad placement, date of publication, dealer, and other provider information. A method of the invention may include one or more of the steps of tracking licensing fees corresponding to licensing the codes to third parties, tracking the advertising used in connection with the codes, and collecting the demographics or indigraphics (i.e. individual demographics) corresponding to the use of the codes. A method may also include tracking a licensing fee for use of the link table information. By way of example, a system executing a method of the invention may be capable of tracking the fact of a person scanning the back of a manufacturer's notebook computer, and either maintaining the multimedia request for information with or for the manufacturer, or auctioning that information to a third party, such as a competitor.

The portal server may comprise a code tracking module for tracking at least one of the data, a link table entry, embedded template calls for interactivity, references to a publisher, a media originator, an ad placement, a date of publication, a dealer, or other provider information, licensing fees corresponding to licensing at least one of the data, a link table entry or a machine readable code to third parties, advertising used in connection with the codes, and demographics or indigraphics corresponding to the use of the codes.

The code tracking module may further be capable of tracking commercial transactions involving leasing the link table(s) associated with the code. A method of the invention may include automatically notifying a manufacturer of an object bearing the code of the scan. A method of the invention may also include tracking and aggregating all scanned information (i.e. the codes.)

Any one of the scanner, the receiver, or the portal server may be capable of supporting downloadable applets and/or templates to provide additional functionality and interactivity. These elements could also support Java applets or work with Jini enabled devices. That is, the system can use and extend the Jini technology.

A method of the invention includes the steps of receiving the code in alphanumeric format (e.g. a combination of numbers and letters printed in conjunction with the machine-readable code) at the user interface and presenting the resulting or corresponding multimedia sequence.

A preferred method of the invention uses the system as described as an alternative method for managing the present DNS schema. Thus, the typical alphanumeric sequence (i.e. CLIC-THRU.COM) may be supplemented or substituted with machine-readable code, which may contain any digital information such as executable code, the templates, or other digital content such as video, audio, or text data. The code may be transparent or non-transparent. In one embodiment of a system executing a method of the invention, the code may link through a URL which then links to an IP address. In another embodiment, the code may link to an IP address which in turn links to a URL.

Under this schema, a method of the invention includes charging companies for signing up for the alternate DNS and tracking their use of the system. The method may also include linking to the ordinary DNS sites. When the system is deployed under the subject invention, the link tables aggregated across the system for resolving the multimedia content locations establish the alternate DNS.

A preferred method of the invention includes the step of tracking the purchasers based on transaction size and frequency and matching the size and frequency to a scanner device such that the device cost is subsidized based on the size and frequency of the transaction.

In an embodiment, a system executing a method of the invention includes a credit card module for working in conjunction with a credit card company. The credit card module is capable of tracking transactions and corresponding referrals. It is further capable of online access to credit limits for transactions including shopping. Its tracking capabilities may include tracking the size and frequency of purchases and corresponding purchasers. The credit card module may be further capable of two-way communication such as obtaining credit and balance information and maintaining transactions and other similar functionality. The system may further contain an affinity information tracking module whereby the module maintains benefit redemption, frequent flyer, or similar affinity information.

In an embodiment, a system executing a method of the invention is further capable of use in conjunction with directory listings, such as the yellow pages, whereby the printed medium is, for example, the yellow pages book.

In an embodiment, a method of the invention includes the step of tracking fees corresponding to transactions initiated via a scan whereby everyone along the consumption and distribution food chains gets paid a percentage of the transaction. The food chain may include portal providers, hardware manufacturers with imbedded scanning technology of the present invention, bandwidth carriers (e.g. telephone; cable, and satellite), media companies, ad firms, persons placing the ad, stores where the transaction was initiated, information providers, and any other parties facilitating the transactions. The store may be a virtual store whereby the store owner only leases one or more link table entry, and links to an ordinary distributor for the balance of the transaction.

In another embodiment, a method of the invention includes the step of tracking one or more of the purchasers or e-commerce transactions based on the transaction size and frequency, and matching the size and frequency to a second product or service device such that a cost of the second product or service is subsidized based on the size and frequency of the transaction initiated via a scan. By way of example, a long distance phone company may be able to bolster its long distance offerings by selling value based services, as can ISP's, and paging companies. By way of another example, a company could offer free or subsidized services (e.g. Internet access) based on a percentage of e-commerce transactions, the ability to sell them as a combined market, or the ability to do targeted and micro-segmented advertising.

The data may comprises a machine-readable code containing any digital information including executable code, templates, or other digital content comprising a video, audio, or text data.

The present invention may be embodied in other specific forms without departing from the spirit or essential attributes thereof and, accordingly, reference should be made to the appended claims, rather than to the foregoing specification, as indicating the scope of the invention.

1. A method of distributing vendibles using a network connecting a scanner, a portal server, and a receiver, the method comprising the steps of:
providing an object containing at least human-readable information and machine-readable codes identifying vendibles;
scanning one of said machine-readable codes containing information identifying a desired vendible using the scanner;
storing the machine-readable code in a memory;
optionally obtaining and storing in the memory a user input information further identifying the desired vendible;
sending the stored information and information identifying the user to the portal server via the network;
receiving the said information at the portal server;
selecting a supplier of said desired vendible; and
sending to at least one of said user and said selected supplier information identifying the other of said user and said selected supplier.

2. A method of distributing vendibles according to claim 1, further comprising the step of supplying said vendibles at a location indicated by said information identifying the user.

3. A method of distributing vendibles according to claim 1, further comprising the steps of:
sending from the portal server to the receiver information identifying a location of said supplier; and
providing said vendibles to said user at said location of said supplier.

4. A method of distributing vendibles according to claim 1, further comprising the steps of:
identifying a plurality of said suppliers;
procuring information from said suppliers with respect to vendibles supplied by each of said plurality of suppliers; and
selecting one from said plurality of suppliers.

5. A method of distributing vendibles according to claim 1, wherein said scanner determines the current location of said scanner;
wherein the said information identifying the user comprises information identifying the determined location of said scanner; and
wherein said step of selecting a supplier includes selecting a supplier convenient to the identified location of said scanner.

6. A method of distributing vendibles according to claim 5, wherein said scanner comprises a receiver for broadcast signals indicative of the location of said scanner.

7. A method of distributing vendibles according to claim 6, wherein said receiver for broadcast signals is a Global Positioning System receiver.

8. A method of distributing vendibles according to claim 1, wherein the suppliers are mobile, further comprising the step of determining the current locations of possible suppliers, and wherein the step of selecting a supplier comprises comparing the current locations of possible suppliers and the user.

9. A method of distributing vendibles according to claim 1, wherein the step of selecting a supplier comprises auctioning the information received at the portal server among at least two possible suppliers.

10. A method of distributing vendibles according to claim 1, which comprises:
running on the portal server a plurality of supplier processes, all supporting a standard interface;
receiving the said information at the portal server in standard form;
identifying a supplier or suppliers pertinent to the vendible in question; and
transferring the said information to at least one supplier process pertinent to the vendible in question.

11. A method of distributing vendibles according to claim 1, which comprises tracking at the portal server a part of the transaction value payable to the supplier.

12. A method of distributing vendibles according to claim 1, wherein the object is a vendible, wherein the machine-readable code identifies that vendible, and which comprises supplying to the user a repeat order of the same vendible.

13. A method of communicating news information via a network connecting a scanner, a portal server, and a receiver, the method comprising the steps of:
providing a printed medium containing information including human-readable news information and a machine-readable code containing a link information related to the human-readable news information;
scanning the machine-readable code from the printed medium using the scanner;
storing the machine-readable code in a memory;
extracting the link information from the machine readable code in the memory;
optionally obtaining and storing user input information in the memory;
sending the link information and the user input information to the portal server via the network;
receiving the link information and the user input information at the portal server;
selecting by the portal server a multimedia news information sequence corresponding to the link information and the user input information;
sending the multimedia information sequence to the receiver via the network;
receiving and storing the multimedia information sequence at the receiver; and
playing the multimedia information sequence via the receiver.

14. A method of communicating news information according to claim 13, further comprising the steps of:
storing the link information and the user input information at the portal server;
identifying newly-available multimedia news information;
selecting a newly-available multimedia news information sequence relevant to the stored news information and user input information;
sending the newly-available multimedia information sequence to the receiver via the network;
receiving and storing the multimedia information sequence at the receiver; and
playing the multimedia information sequence via the receiver.

15. A system for communicating information via a telecommunications network by initiating a communication from an object containing scannable provider information, the system comprising:
telecommunications apparatus including a scanner comprising a memory, the scanner receiving data by scanning from said object and storing said data in said memory, the data comprising link information corresponding to the provider information,
a user interface for receiving user input information, the user input information capable of being stored in the memory;
the telecommunications apparatus being connected to the network for communicating the link information and the user input information via the network and receiving information via the network; and
a portal server in communication with the telecommunications apparatus via the network, the portal server receiving the link information and the user input information, selecting an information sequence corresponding to the link information and the user input information, and causing the information sequence to be transmitted via the network to the telecommunications apparatus.

16. A system for communicating information according to claim 15, wherein the said telecommunications apparatus comprises a telephone, and wherein the portal server transmits information to the telephone in the form of synthesized speech.

17. A system for communicating information according to claim 16, wherein the portal server communicates with a user by means of synthesized speech replayed by the telephone to the user and user input entered on a keypad of the telephone.

18. A system for communicating information according to claim 15, wherein the scanner scans information from a printed medium.

19. A system for communicating information according to claim 15, wherein the said telecommunications apparatus is a pager which displays text, and wherein the portal server transmits information in the form of text to be displayed on such a pager.

20. A system for communicating information according to claim 15, wherein the telecommunications apparatus includes a facsimile machine for receiving information from the telecommunications network, and the portal server sends facsimile messages that include codes readable by the said scanner.

21. A method of commercial administration using a network connecting a scanner, a portal server, and a receiver, the method comprising the steps of:
generating a written record of a transaction, which record includes machine-readable code identifying at least the transaction and a database containing records of the transaction and accessible from the network via the portal server;
scanning said machine-readable code using the scanner;
storing the machine-readable code in a memory;
optionally obtaining and storing a user input information;
sending the stored information and information identifying the user to the portal server via the network;
receiving the said information at the portal server; and
accessing the records of the transaction in the said database.

22. A method of commercial administration according to claim 21, which comprises downloading from the database to the receiver the records of the transaction.

23. A method of commercial administration according to claim 21, wherein the written record is a receipt, and which comprises importing the downloaded records into an expense accounting system.

24. A method of commercial administration according to claim 21, which comprises automatically transferring funds to pay a debt created by the transaction.

25. A method of commercial administration according to claim 21, which comprises appending information identifying the user to the database.

26. A method of commercial administration according to claim 25, wherein the transaction is a sale, and the database contains product and purchaser information.

27. A method of commercial administration according to claim 25, which comprises using the product and purchaser information for warranty administration.

28. A method of commercial administration according to claim 25, which comprises using the product and purchaser information for maintenance contract administration.

29. A method of commercial administration according to claim 25, which comprises using the product and purchaser information for the supply of upgrades.

30. A method of contact administration using a network connecting a scanner, a portal server, and a receiver, the method comprising the steps of:
distributing business cards that identify and provide contact details for a person and include machine-readable code at least identifying the said person;
scanning said machine-readable code using the scanner;
storing the machine-readable code in a memory;
sending the stored information and information identifying a user to the portal server via the network;
receiving the said information at the portal server;
storing in a database associated with the said person at least the information identifying the said user; and
notifying at least some users identified in the said database of changes in the contact details of the said person.

31. A method of contact administration according to claim 30, comprising automatically notifying all users identified in the said database of changes in the contact details of the said person.

32. A method of contact administration according to claim 31, comprising the repeated step of deleting users from the database.

33. A method of contact administration according to claim 30, comprising the step of reviewing the users identified in the database when a change in the contact details of the said person occurs, and notifying only some said users of the change.

34. Apparatus for selection of entertainment programs, comprising:
a printed medium containing entries giving human-readable information on respective available entertainment programs, and each including a machine-readable code;
a scanner for scanning the machine readable codes;
a portal server connected to said scanner via a network; and
a receiver connected to said portal server via said network;
said scanner being capable of transmitting said scanned code to said portal server; and
said portal server being responsive to said transmitted scan to transmit said entertainment program to said receiver.

35. Apparatus according to claim 34, wherein said portal server causes said user to be charged for viewing said program.

36. Apparatus for selection of entertainment programs, comprising:
a printed medium containing entries giving human-readable information on respective available entertainment programs, and each including a machine-readable code;
a scanner for scanning the machine readable codes;
a portal server connected to said scanner via a network; and
a receiver connected to said portal server via said network;
said scanner being capable of transmitting said scanned code to said portal server; and
said portal server being responsive to said transmitted scan to transmit to said receiver information enabling said receiver to show said entertainment program to a user.

37. Apparatus according to claim 36, wherein said machine-readable code includes data identifying a time and channel for a television program, and said responsive apparatus comprises a video recorder.
